(19) United States
(12) Patent Application Publication
(10) Pub. No.: US 2025/0128433 A1
(43) Pub. Date: Apr. 24, 2025

(54) CABLE PROCESSING MACHINE AND METHOD FOR SELECTIVELY RECEIVING A CABLE GUIDE UNIT FROM A MAGAZINE OF A CABLE PROCESSING MACHINE

(71) Applicant: komax Holding AG, Dierikon (CH)

(72) Inventors: Daniel GUT, Weggis (CH); Kurt ULRICH, Stans (CH)

(73) Assignee: komax Holding AG, Dierikon (CH)

(21) Appl. No.: 18/918,348

(22) Filed: Oct. 17, 2024

(30) Foreign Application Priority Data
Oct. 20, 2023 (EP) 23204913.0

(51) Int. Cl. B25J 15/04; H02G 1/00

(52) U.S. Cl. CPC B25J 15/0491; B25J 15/0433; H02G 1/00

(57) ABSTRACT

A cable processing machine includes a swivel arm on the cable supply side, a magazine for a plurality of cable guide units and a fixing device for a cable guide unit, wherein the fixing device is arranged on the swivel arm, can be actuated automatically and serves for selectively receiving a cable guide unit from the magazine in accordance with a guide unit selection signal. Upon the reception of the guide unit selection signal, the cable processing machine swivels the swivel arm into a corresponding position relative to the magazine and receives the selected cable guide unit from the magazine by using the fixing device.

### CROSS REFERENCE TO RELATED APPLICATIONS

Applicant claims priority under 35 U.S.C. § 119 of European Application No. 23204913.0 filed Oct. 20, 2023, the disclosure of which is incorporated by reference.

### BACKGROUND OF THE INVENTION

### 1. Field of the Invention

Embodiments of the present disclosure pertain to a cable processing machine and to a method for selectively receiving a cable guide unit from a magazine of a cable processing machine.

### 2. Description of the Related Art

Cable processing machines are used for carrying out one or more processes on cables, particularly on cable ends, in an automated manner. In this case, it is desirable to use one and the same cable processing machine for a plurality of cables that may have different properties. Such differences include, for example, the cable cross section, the insulation thickness and the like.

It is known to change the cable when a different cable should be processed. Such a change sometimes also makes it necessary to change an associated guide tube and an associated guide hose, into which the cable has to be threaded. In this context, document EP 1 548 902 B1 discloses a corresponding threading aid. Document EP 1 548 903 B1 discloses a technology, in which a cable processing machine comprises a feed device, which is able to move to a magazine that can be loaded with multiple guide tubes. After receiving a guide tube, a cable still has to be threaded into said guide tube, i.e. the cable change itself is not automated. Consequently, there is a need for a cable processing machine, in which a cable change can be carried out in an automated manner.

### SUMMARY OF THE INVENTION

A cable processing machine according to one aspect of the invention and a method according to another aspect of the invention for selectively receiving a cable guide unit from a magazine of the cable processing machine are disclosed. Advantageous enhancements are discussed below.

According to one aspect, a cable processing machine has a swivel arm on the cable supply side, a magazine for a plurality of cable guide units and a fixing device for a cable guide unit, wherein said fixing device is arranged on the swivel arm and can be actuated automatically. The fixing device serves for selectively receiving a cable guide unit from the magazine in accordance with a guide unit selection signal. The cable processing machine is configured in such a way that it swivels the swivel arm into a corresponding position relative to the magazine upon the reception of the guide unit selection signal and receives the selected cable guide unit from the magazine by using the fixing device.

According to another aspect, a method for selectively receiving a cable guide unit from a magazine of a cable processing machine is disclosed. The cable processing machine has a swivel arm on the cable supply side, the magazine and a fixing device for the cable guide unit, wherein said fixing device is arranged on the swivel arm and can be actuated automatically. The method comprises the steps of receiving a guide unit selection signal that designates the cable guide unit in the magazine, swiveling the swivel arm into a corresponding position relative to the magazine and receiving the selected cable guide unit from the magazine—by using the fixing device.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a perspective view of a section of a cable processing machine according to the prior art;

FIG. 2 shows a perspective view of a section of a cable processing machine according to an embodiment;

FIG. 3 shows a top view of a portion of the cable processing machine illustrated in FIG. 2;

FIG. 4 shows a perspective view of a cable guide unit of the cable processing machine illustrated in FIG. 2;

FIG. 5 shows a perspective view of a swivel arm on the cable supply side and magazine elements of the cable processing machine illustrated in FIG. 2; and

FIGS. 6A, 6B, 6C, and 6D show side views of a section of the cable processing machine illustrated in FIG. 2 at different points in time in order to elucidate the processing sequence according to an embodiment.

### DETAILED DESCRIPTION OF PREFERRED EMBODIMENTS

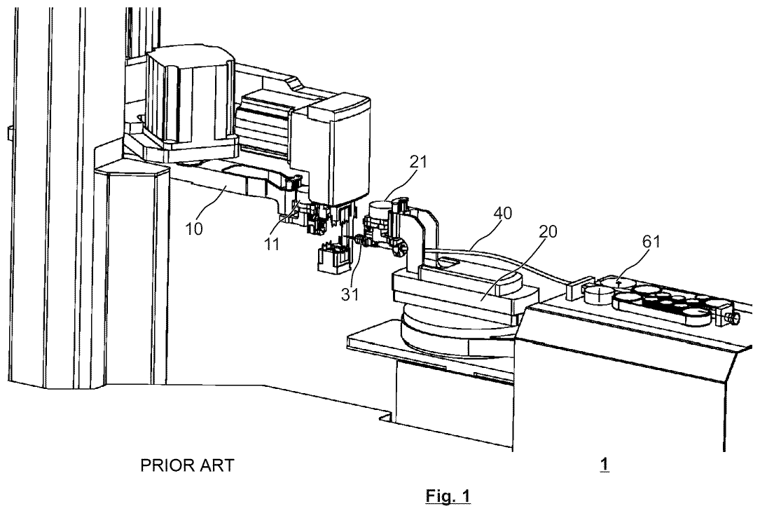

FIG. 1 shows a perspective view of a portion of a conventional cable processing machine 1. A cable is supplied, e.g. from a (not-shown) reel or the like, from the right side in the drawing in FIG. 1. This side is referred to as the cable supply side. A cable feeder 61 that is followed by a guide hose 40 serves for supplying the cable. A guide tube 31 following the guide hose 30 is fastened in front of a cable gripper 21. The guide hose 40, the cable gripper 21 and the guide tube 31 are arranged on a swivel arm 20 on the cable supply side. Another swivel arm 10 with a cable gripper 11, to which the supplied cable is transferred, is arranged opposite of the swivel arm 20 on the cable supply side.

A cable with a certain cross section usually is clamped into and processed in the cable processing machine 1. The cable has to be precisely guided in order to be processed as flawlessly as possible, wherein this is achieved in that the guide hose 40 and the guide tube 31 have a suitable inside diameter. The inside diameter, particularly of the guide tube 31, generally is only slightly larger than the outside diameter of the cable. The cable gripper 21 is opened during the longitudinal transport (feed) of the cable such that the cable feeder 61 can feed the cable through the guide hose 40 and the guide tube 31.

In order to allow a stable and precise guidance in the conventional cable processing machine 1, at least the guide tube 31, if applicable also the guide hose 40, needs to be changed when the cable being processed is replaced with a cable having a larger or smaller outside diameter. To this end, the new cable needs to be threaded into the new guide tube 31, but this is a manual process and therefore correspondingly time-consuming.

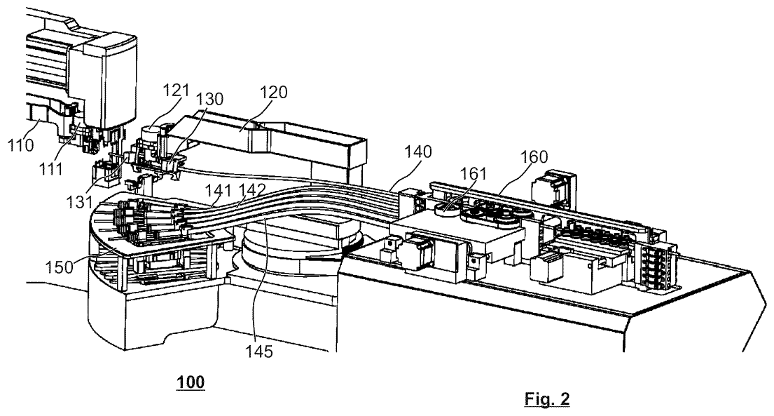

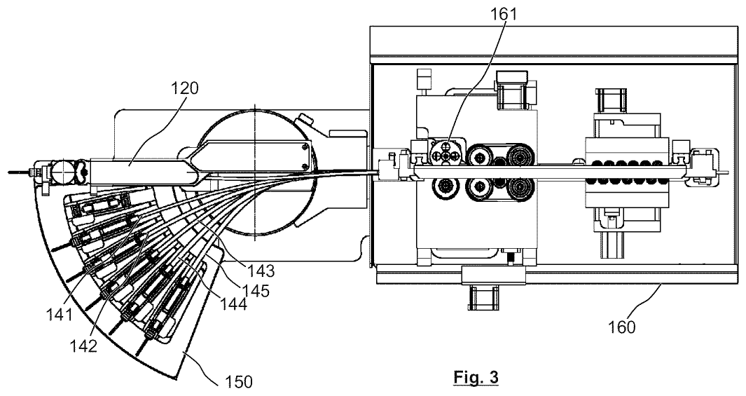

FIG. 2 shows a perspective view—analogous to FIG. 1—of a portion of a cable processing machine 100 according to the present disclosure. FIG. 3 shows the elements of FIG. 2 in the form of a top view. FIG. 2 and FIG. 3 are described jointly for the sake of clarity.

The cable is once again supplied, e.g. from a (not-shown) reel or the like, from the right side in the drawing in FIG. 1. This side is referred to as the cable supply side. A cable changer 160 with a cable feeder 161 serves for supplying the cable. For example, the cable changer is a linear cable changer that is configured as described in document EP 1 213 800 B1, the disclosure of which is hereby included in the present disclosure by reference. However, this configuration is merely exemplary and it is also conceivable to use different types of cable changers such as rotative or swiveling cable changers.

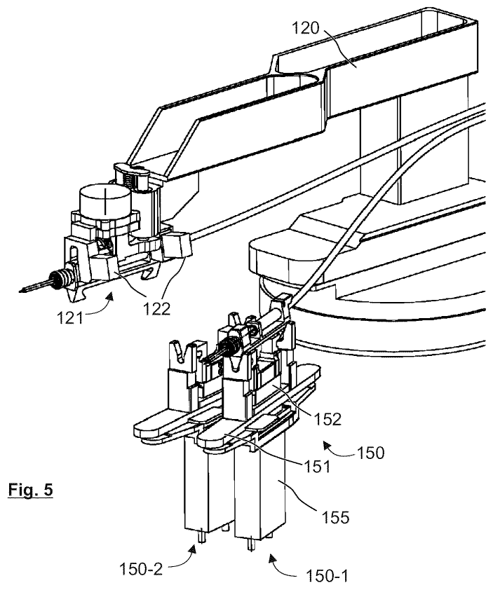

A plurality of guide hoses 140 . . . 145 lead into the cable changer 160, wherein said guide hoses have, if applicable, different inside diameters and accordingly accommodate cables that respectively have different properties, e.g. different outside diameters. An associated guide unit 130-1 . . . 130-6 follows each guide hose 140 . . . 145. The guide units 130-1 . . . 130-6 are accommodated in a magazine 150 (see also FIG. 5 and the corresponding description). A fixing device 121 is arranged on a swivel arm 120 on the cable supply side (see also FIG. 5 in the corresponding description). Another swivel arm 110 with a cable gripper 111, to which the supplied cable is transferred, is arranged opposite of the swivel arm 120 on the cable supply side.

The fixing device 121 can be actuated automatically, e.g. by means of a superordinated machine control. The cable processing machine 100 is configured in such a way that, upon the reception of a guide unit selection signal, it swivels the swivel arm 120 into a position on the magazine, in which the guide unit (e.g. the certain type of guide unit) designated by the guide unit selection signal can be received. The thusly selected guide unit 130-1 . . . 130-6 is then taken over, or received, from the magazine 150 by using the fixing device 121. In the embodiment illustrated in FIG. 2, the magazine 150 is arranged underneath the swiveling range of the swivel arm and, as an example, the first of the guide units (cable guide unit 130-1) is received on the fixing device 121 of the swivel arm 120.

The cable guide units 130-1 . . . 130-6 differ at least insofar as that at least one of the cable guide units 130-1 . . . 130-6 differs from another cable guide unit 130-1 . . . 130-6 with respect to the suitability for the type of cable to be guided thereby. As a rule, this concerns the outside diameter of the guided cable. For example, the inside diameter of one cable guide unit 130-1 . . . 130-6 differs from the inside diameter of at least one other cable guide unit 130-1 . . . 130-6.

Furthermore, at least one of the cable guide units 130-1 . . . 130-6 is fitted with a cable to be guided. It is preferred that all cable guide units 130-1 . . . 130-6 are respectively fitted with a cable to be guided.

All cables are inserted into the cable changer 160, extend through the associated guide hose 140 . . . 145 and the associated guide tube and remain at this location, namely even if the associated guide unit 130-1 . . . 130-6 is located in the magazine 150. A cable change is carried out in that the cable changer 160 is displaced in order to transport the desired cable and the corresponding guide unit 130-1 . . . 130-6 is removed from the magazine 150, i.e. received in the fixing device 121.

It should be noted that the number of cable guide units 130-1 . . . 130-6 in the exemplary embodiment shown amounts to 6, but may also differ from 6. The number of cable guide units 130-1 . . . 130-6 particularly amounts to at least 2.

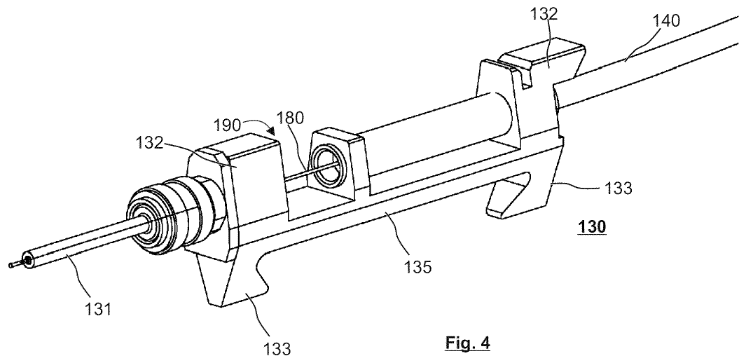

FIG. 4 shows a perspective view of a guide unit that is identified by the reference symbol 130 and representative for each of the cable guide units 130-1 . . . 130-6 even though the diameter, for example, of the guide tube 131 and/or the guide hose 140 may differ. The guide unit 130 comprises a carrier 135, on which the guide tube 131 and the guide hose 140 are fastened. The cable 180 is routed through the guide hose 140 and the guide tube 131 and exits the guide tube 131 on its end. A recess 190 makes it possible to grip the cable and to close a (not-shown) threading aid when the cable gripper is opened. The carrier 135 has one or more coupling surfaces 132, 133 that are designed, for example, in a wedge-shaped manner and allow fixing on a respectively associated counter piece on the swivel arm 120 or the magazine 150, respectively.

FIG. 5 shows a perspective view of the gripper arm 120 and a portion of the magazine 150. As an example, two magazine elements 150-1, 150-2 are illustrated in this figure, wherein a cable guide unit 130 is received in the magazine element 150-1. It should be noted that the number of magazine elements on the magazine 150 corresponds to the number of cable guide units that can be accommodated therein. It is preferred that the magazine elements 150-1, 150-2 are configured identically. The configuration of the magazine element 150-1 is described as an example. The magazine element 150-1 comprises a lifting plate 151, a lifting cylinder 155 and a clamping device 152 such as a clamping cylinder. The fixing device 121 on the swivel arm 120 comprises a clamping device 122 such as a clamping cylinder. The guide unit 130 accommodated in the magazine 150 (in the respective magazine unit 150-1) is aligned with the lower coupling surfaces 133 and fixed with the aid of the clamping device 152 by exerting pressure upon the lower coupling surfaces 133. The lifting plate 151 can be moved vertically by means of the lifting cylinder 155. In the fixing device 121, the upper coupling surfaces 132 are aligned with the clamping device 122 and fixed thereon by exerting pressure.

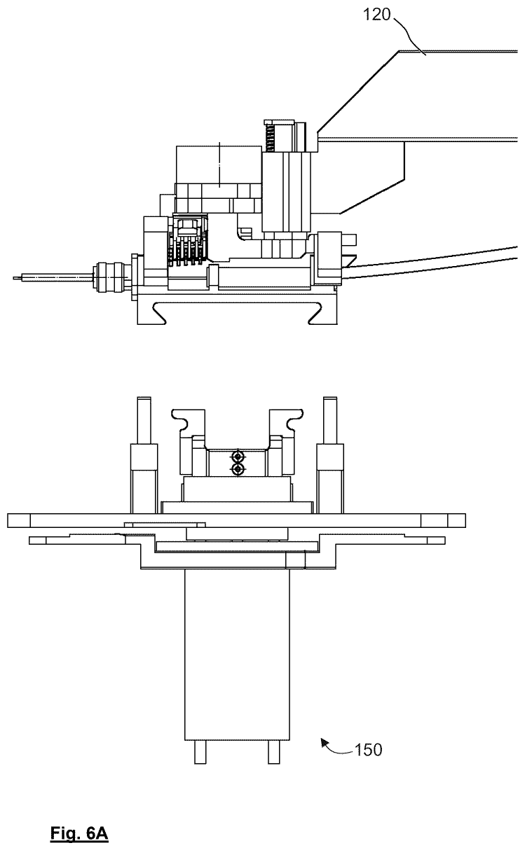

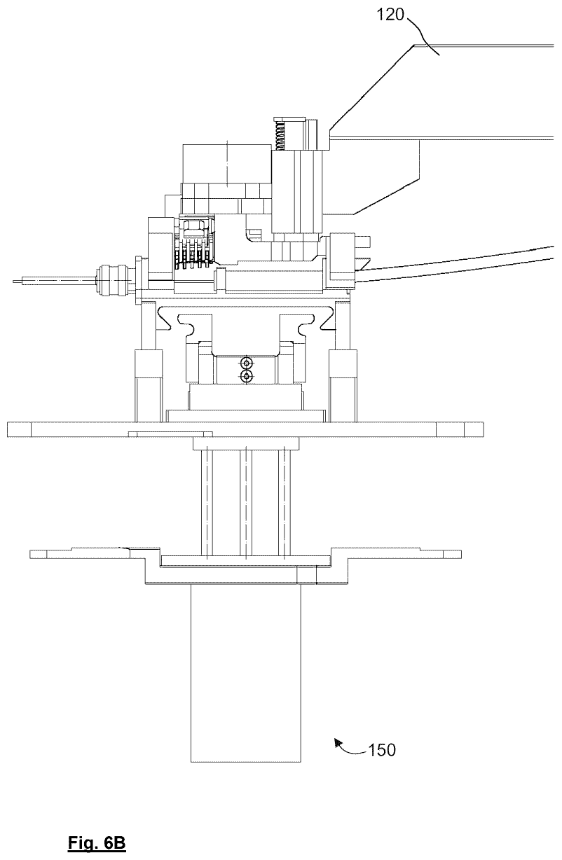

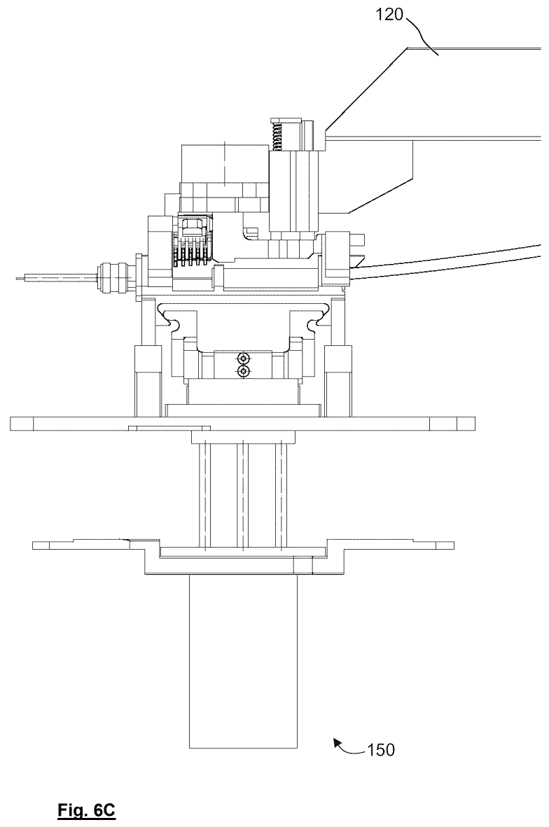

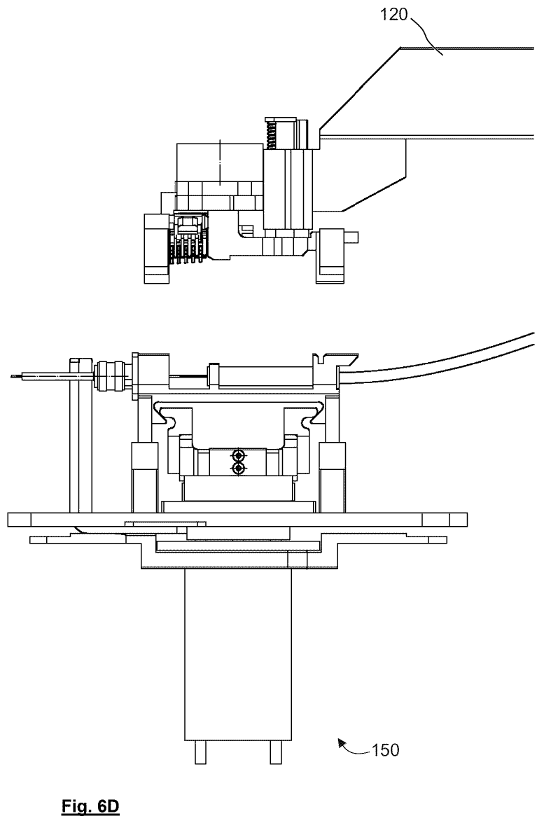

FIGS. 6A to 6D show a sequence of steps of a method for transferring a guide unit 130 from the swivel arm 120 to the magazine 150. In FIG. 6A, the swivel arm has been swiveled such that the fixing device 122 is positioned above an empty space in the magazine 150 (an empty magazine element 150-1, 150-2). In FIG. 6B, the lifting cylinder 155 of the associated magazine element 150-1, 150-2 moves upward such that the clamping device 152 arranged on the lifting plate 151 is aligned relative to the lower coupling surfaces 133 of the guide unit 130. In FIG. 6C, the clamping device 122 on the fixing device 122 of the swivel arm 120 is released and the clamping device 152 moves outward and thereby clamps the guide unit 130. In FIG. 6D, the lifting cylinder 155 moves downward and therefore has received the guide unit 130. In the case of a cable change, a guide unit 130 that currently is no longer needed is positioned in an empty space in the magazine 150 (an empty magazine element 150-1, 150-2) such that the swivel arm 120 is ready to receive a different guide unit 130 of the currently required type. During a transfer from the magazine 150 to the swivel arm 120, the above-described steps are carried out in reverse sequence in order to receive the required guide unit 130. The steps for transferring the guide unit 130 from the swivel arm 120 to the magazine 150 naturally do not have to be carried out if the swivel arm 120 already is free of a guide unit 130; in fact, the swivel arm 120 can in this case receive the required guide unit 130 directly from the magazine 150, i.e. the above-described steps are carried out in reverse sequence.

Although only a few embodiments of the present invention have been shown and described, it is to be understood that many changes and modifications may be made thereunto without departing from the spirit and scope of the invention.

What is claimed is:

1. A cable processing machine (100) with:
a swivel arm (120) on the cable supply side;
a magazine (150) for a plurality of cable guide units (130-1 . . . 130-6); and
a fixing device (121) for a cable guide unit (130-1 . . . 130-6), wherein said fixing device is arranged on the swivel arm (120), can be actuated automatically and serves for selectively receiving a cable guide unit (130-1 . . . 130-6) from the magazine (150) in accordance with a guide unit selection signal,
wherein the cable processing machine (100) is configured in such a way that it swivels the swivel arm (120) into a corresponding position relative to the magazine (150) upon the reception of the guide unit selection signal and receives the selected cable guide unit (130-1 . . . 130-6) from the magazine (150) by using the fixing device (121).

2. The cable processing machine (100) according to claim 1, wherein at least one of the cable guide units (130-1 . . . 130-6) differs from one of the other cable guide units (130-1 . . . 130-6) with respect to the suitability for the type of cable to be guided thereby, particularly with respect to the cable cross section and/or the insulation thickness.

3. The cable processing machine (100) according to claim 1, wherein at least one of the cable guide units (130-1 . . . 130-6) in the magazine, particularly each of the cable guide units (130-1 . . . 130-6), is fitted with a cable to be guided.

4. The cable processing machine (100) according to claim 1, wherein the cable guide unit (130-1 . . . 130-6) comprises a carrier (135) with at least one coupling surface (132, 133), and wherein the coupling surface (132, 133) is designed for interacting with the fixing device (121).

5. The cable processing machine (100) according to claim 4, wherein the coupling surface (132, 133) is designed in a wedge-shaped manner.

6. The cable processing machine (100) according to claim 1, wherein the fixing device (121) comprises at least one clamping device (122), and wherein the clamping device (122) is designed for interacting with the cable guide unit (130-1 . . . 130-6), particularly with the at least one coupling surface (132, 133).

7. The cable processing machine (100) according to claim 1, wherein the magazine (150) comprises a plurality of magazine elements (150-1, 150-2) for respectively accommodating one of the cable guide units (130-1 . . . 130-6).

8. The cable processing machine (100) according to claim 7, wherein at least one of the magazine elements (150-1, 150-2), particularly each of the magazine elements (150-1, 150-2), comprises a clamping device (152), particularly a clamping cylinder, for fixing a received cable guide unit (130-1 . . . 130-6).

9. The cable processing machine (100) according to claim 7, wherein at least one of the magazine elements (150-1, 150-2), particularly each of the magazine elements (150-1, 150-2), comprises a lifting plate (151) that is coupled to a lifting cylinder (155) and serves for taking hold of a cable guide unit (130-1 . . . 130-6), particularly the at least one coupling surface (132, 133) of the cable guide unit (130-1 . . . 130-6).

10. A method for selectively receiving a cable guide unit (130-1 . . . 130-6) from a magazine (150) of a cable processing machine (100), wherein the cable processing machine (100) comprises a swivel arm (120) on the cable supply side, the magazine (150) and a fixing device (121) for the cable guide unit (130-1 . . . 130-6), wherein said fixing device is arranged on the swivel arm (120) and can be actuated automatically, and wherein the method comprises the steps of:
receiving a guide unit selection signal that designates the cable guide unit (130-1 . . . 130-6) in the magazine (150);
swiveling the swivel arm (120) into a corresponding position relative to the magazine (150); and
receiving the selected cable guide unit (130-1 . . . 130-6) from the magazine (150) by using the fixing device (121).
